(19) United States
(12) Patent Application Publication
(10) Pub. No.: US 2018/0222645 A1
(43) Pub. Date: Aug. 9, 2018

(54) COLLAPSIBLE DISPENSER UTENSIL AND CONTAINER SYSTEM

(71) Applicant: Eric B. Nicholes, Orem, UT (US)

(72) Inventor: Eric B. Nicholes, Orem, UT (US)

(21) Appl. No.: 15/882,736

(22) Filed: Jan. 29, 2018

Related U.S. Application Data
(60) Provisional application No. 62/452,351, filed on Jan. 30, 2017.

(51) Int. Cl. B65D 51/24; B65D 43/16; B65D 51/20; G01F 19/00

(52) U.S. Cl. CPC B65D 51/246; B65D 43/169; B65D 51/20; B65D 2543/00092; B65D 2251/0021; B65D 2251/0093; G01F 19/002

(57) ABSTRACT

A container system including manufacturing and assembling methods for coupling together a collapsible and expandable dispenser inside a lid of the container. The teachings allow a desired dispenser to be collapsed and housed, removed, expanded, replaced and stored in a lid, closure or packaging. A container system can include a reservoir for bulk product and a lid affixed to an opening of the container. An internal surface of the lid selectively connects to a collapsible dispensing utensil configured expand to an un-collapsed state so as to hold and dispense a predetermined amount of the product. The collapsible dispensing utensil is configured to be removed and reattached to the same interior surface of the lid so as to occupy a smaller volume within the lid as opposed to being disposed within the container along with the bulk product.

### CROSS REFERENCE TO RELATED APPLICATIONS

This application claims priority to and the benefit of U.S. Provisional Patent Application 62/452,351 filed Jan. 30, 2017, the contents of which are incorporated herein by reference in its entirety and for all purposes.

### FIELD OF THE INVENTION

The present invention relates to improved measuring utensils, packaging, and containers. Certain embodiment disclosed herein include novel lid closures and connected collapsible dispensing utensils.

### BACKGROUND

Many products are often sold with dosage or serving scoops disposed inside the container of the product so that the users can remove a proper incremental amount of the bulk product held within the container for each use. Traditionally, a measuring dispensing utensil may have been provided within the container. For example, in the instance of a nutritional powder product container, a measuring utensil is often provided within the container with the powdered product. In such traditional packaging a purchaser has been required to search through the powder product to find this dispensing scoop often buried therein.

Often when the measuring utensil is subsequently replaced back into the bulk product such as nutritional powder the lid is placed back over the opening of the container. In subsequent use the purchaser is required to once again find and retrieve the measuring utensil in the form of a scoop from the powder and container. Moreover, as the volume of powder is removed the ability to see and retrieve the scoop is further limited.

Thus, there is a need for improvements to the measuring utensil apparatus as well as the overall container system in view of that conventionally pursued.

### SUMMARY

A collapsible dispenser utensil is disclosed for dispensing a bulk material held within a container. The collapsible dispenser utensil can include a collapsible cup portion and a handle attached to the collapsible cup portion. The collapsible cup portion is made of a flexible polymer such as a silicone material. The collapsible dispenser utensil can further include a relatively rigid rim made of a rigid plastic material according to some embodiments.

The handle can include mechanical means for attaching the utensil to an interior surface of a container lid.

The collapsible cup portion has foldable sides. And, the foldable sides have a progressively smaller diameter such that successive sides progressively fold within a perimeter of an upper rim when collapsed.

A container system is disclosed that includes the collapsible dispenser utensil and a lid including an interior surface. The interior surface of the lid includes mechanical means for repeatedly attaching to and releasing the collapsible dispenser utensil thereto. The container system can further include a container reservoir coupled to the lid and containing the bulk product. The container system can further include a seal configured to effectively seal an opening of the container so as to prevent moisture, contaminants, or tampering from entering the container and interfering with the bulk material. In some embodiments, the collapsible dispenser utensil may be disposed between the seal and the inner surface of the lid.

The attaching means of the lid may include a peg or latching means disposed on the lid. The peg may be part of various interlocking features that may interlock with a handle of the collapsible dispensing utensil. The lid can further include a pivotable accessible door forming the internal surface of the lid to which the collapsible utensil is releasably attached. The attaching means of the utensil can include a hole corresponding to the peg disposed on the lid. And, the means for attaching the collapsible utensil may be disposed on the internal surface of the hinged internal opening.

### BRIEF DESCRIPTION OF THE DRAWINGS

FIG. 1 illustrates an expanded collapsible dispenser utensil;

FIG. 1B illustrates the collapsible dispenser utensil of FIG. 1 in a collapsed state;

FIG. 1C illustrates parts of the collapsible dispenser utensil of FIGS. 1A and 1B;

FIGS. 2-4 illustrate a collapsible dispenser utensil affixed to the interior surface of a lid employing various mechanical means therefore;

FIG. 5A illustrates a comparison of the height of a conventional dispenser scoop with a collapsed dispenser utensil according to the present invention;

FIG. 5B illustrates a container system incorporating the collapsed dispenser, lid and seal;

FIG. 6 illustrates a plurality of different sized collapsible dispenser utensils;

FIG. 7 illustrates examples of different shapes of collapsible dispenser utensils; and

FIGS. 8A and 8B illustrate examples of pivotal “flip-top” lids incorporating and providing access to an internally secured collapsible dispenser utensil as well as the contents of the container.

### DETAILED DESCRIPTION

Often it is desirable to use a measuring or dispensing utensil to access and dispense the contents of a container. The substance of a product held within a container can be a powder or liquid substance and examples of dispensing utensils include spoons, measuring cups, scoops, spatulas, and other dispensing utensils. In some instances the dispensing utensil is provided along with the container. In some instances the extent of material that is dispensed by the utensil is predefined by a manufacturer. For example, the size of the utensil can be preconfigured for a measured amount of product in the container for each individual use. In other embodiments multiple different sizes or of utensils can be provided. Or, the utensil can include markings or other manner of graduation for measuring how much of the substance within the container is to be held by and dispensed by the utensil. As disclosed herein the size of the container is often of a concern and the dispensing utensil can add to the overall size of the container as it generally takes up space within the container.

According to various embodiments disclosed hereinafter a collapsible dispensing utensil is provided. The collapsed dispensing utensil may reduce the overall height or thickness of the dispensing utensil. The collapsed dispensing utensil may be disposed within a lid of the container as opposed to being disposed within the container along with the dispensable product. According to the teachings herein, the dispensing utensil may be housed, removed, expanded, replaced and stored in a lid, closure or packaging. The dispensing utensil can be releasably affixed to an interior surface of the lid of the container so as to be readily located and detached therefrom for use and collapsed and reattached to the inner surface after use.

The lid of the container may be sized so as to contain the collapsed dispensing utensil above a seal of the container. And, the lid of the container may include a pivotable top which provides access to the inner surface of the lid to which the dispensing utensil is releasably affixed thereto. The pivotable top also allows access to the product held within such container upon removal of the seal without removal of the entire lid by rotation of inner surface threads of the lid and mating outer surface threads of the container.

In addition, in various edible substance situations the seal is used to cover and seal an opening of the container. This seal can define an interior of the container and be removably affixed to the container so as to prevent air, moisture, or contaminants from entering the interior of the container. Often the seal defines a space between the top of the container over which the seal extends and an interior surface of the lid. And, as disclosed by the inventor of this patent application it has been found to be desirable to reduce the distance between the seal and the interior surface of the lid yet still be able to hold a collapsible utensil therein. This typically unused space is advantageously used for housing the collapsed dispensing utensil which is retained therein. Retention means for temporarily affixing the dispensing utensil to an interior surface of the lid allows for a reliable location, removal, and relocation, for retaining the dispensing utensil within the container of the bulk product without intermixing the utensil into the bulk product.

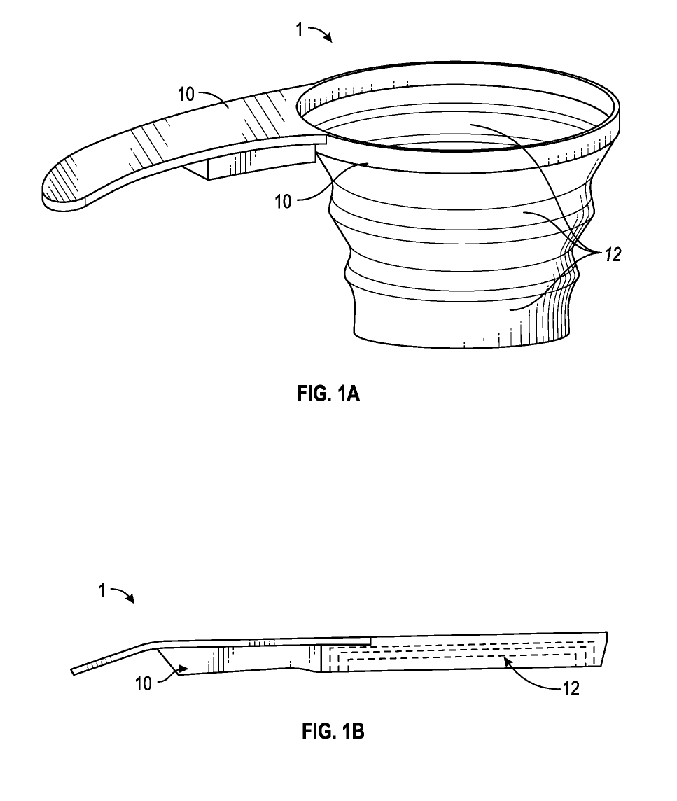

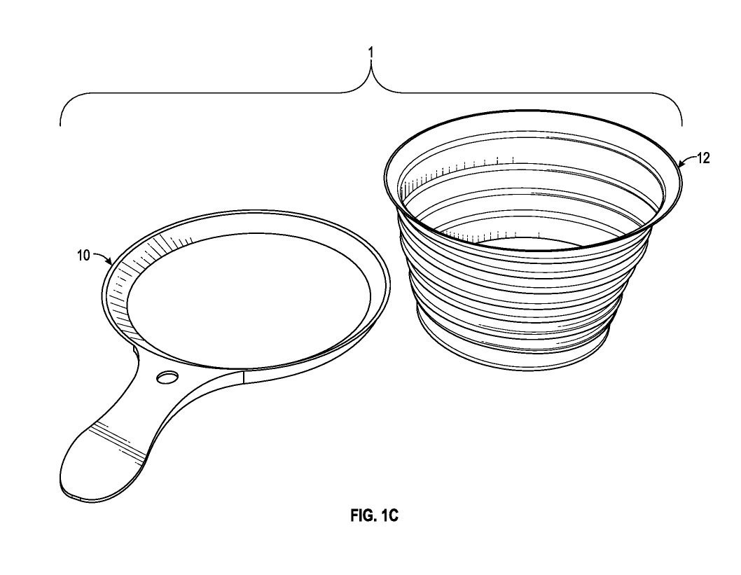

Referring now to the invention in more detail a collapsible and expandable dispensing utensil 1 in the form of a scoop or cup is shown in FIGS. 1A, 1B, and 1C. According to this embodiment, the dispensing utensil 1 may include two parts. The dispensing utensil 1 includes a relatively rigid upper part 10 forming the rim and handle. The upper part 10 can be made from plastic using a number of differing types of resins depending on its use. The lower part 12 of the dispensing utensil 1 includes the collapsible bowl of the measuring utensil. The collapsible cup 12 is made from combinations of resins to achieve a membrane that is flexible enough to enclose into itself through folds on the walls of the collapsible cup 12. Each section of fold is slightly less in diameter going from top to bottom such that each subsequent section of the walls of the cup 12 folds up into the center of the rim of the upper part 10. Thus a lower-most portion of the cup 12 most distal to the rim 10 when expanded has a smallest diameter; and an upper-most portion of the cup 12 proximate to the rim 10 has a largest diameter. Portions of the cup 12 between the upper-most portion and lower-most portion have intermediate diameters there between so as to collectively hold the desired measured amount of product.

The dispensing utensil 1 consists of combinations of resins developed so as to properly expand, collapse, effectively scoop and to pour product from the utensil 1 effectively with minimal residue remaining. The upper part 10 including the rim and handle can be adhered or bonded by various manufacturing processes to the lower portion 12 of the dispensing utensil 1 as illustrated in separate parts in FIG. 1C. Once bonded together the utensil 1 may be repeatedly expanded as shown in FIG. 1A and collapsed as shown in FIG. 1B. During expansion and retraction the rim and handle 10 may be made of a relatively hard plastic material so as to keep the desired form of the dispensing utensil 1. After, dispending the product, the cup or bowl 12 of the dispended utensil may again be collapsed and affixed within the lid of the container system as discussed hereinafter.

FIG. 2 illustrates a perspective top view showing a container system 200 including a collapsible dispensing utensil 205 releasably coupled to the underneath interior surface of a lid 210. The interior surface of the lid 210 may be defined by a lip or threads surrounding the surface to which the lid 210 attaches to a container reservoir. The lid 210 includes interlocking means in the form of resilient biasing tabs 212 which releasably pinch or hold the sides of a handle 220 of the collapsible dispensing utensil 205 thereby securing the collapsed dispensing utensil 205 to the interior surface of the lid 210. The collapsed dispensing utensil 205 includes a single plastic support fin 215 on the underside middle location of a handle 220 that allows users to pinch the support fin 215 with fingers as a way to remove and re-attach the dispensing utensil 205 onto and off of the lid 210.

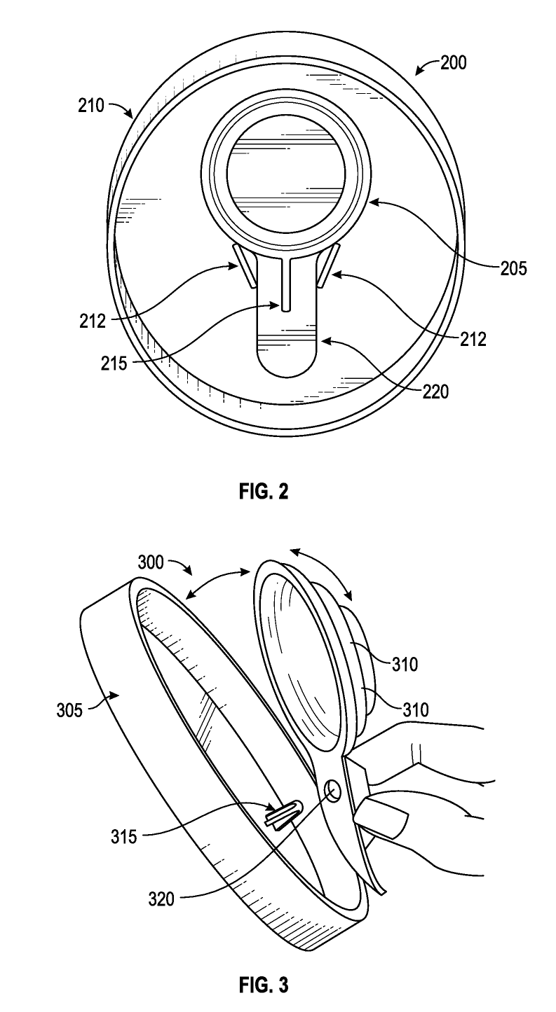

FIG. 3 illustrates a container system 300 showing the underside of a closure lid 305 containing the attachable and collapsible dispensing utensil 310. Means for releasably attaching the dispensing utensil 310 to the interior surface of the lid 305 according to this embodiment includes a mating protrusion in the form of a peg 315 and corresponding mating void in the form of a hole 320 attachment for temporarily securing and selectively releasing the dispensing utensil 310 with the inner surface of the lid 305. This attachment design has a female hole 320 in the middle of the handle of the dispending utensil 310 that can be easily attached and removed to a male peg 315 that is a part of the lid 305. The peg and hole may be designed to have an interference fit such that they are held together until a sufficient manual force is applied to detach the utensil 310 from the lid 305.

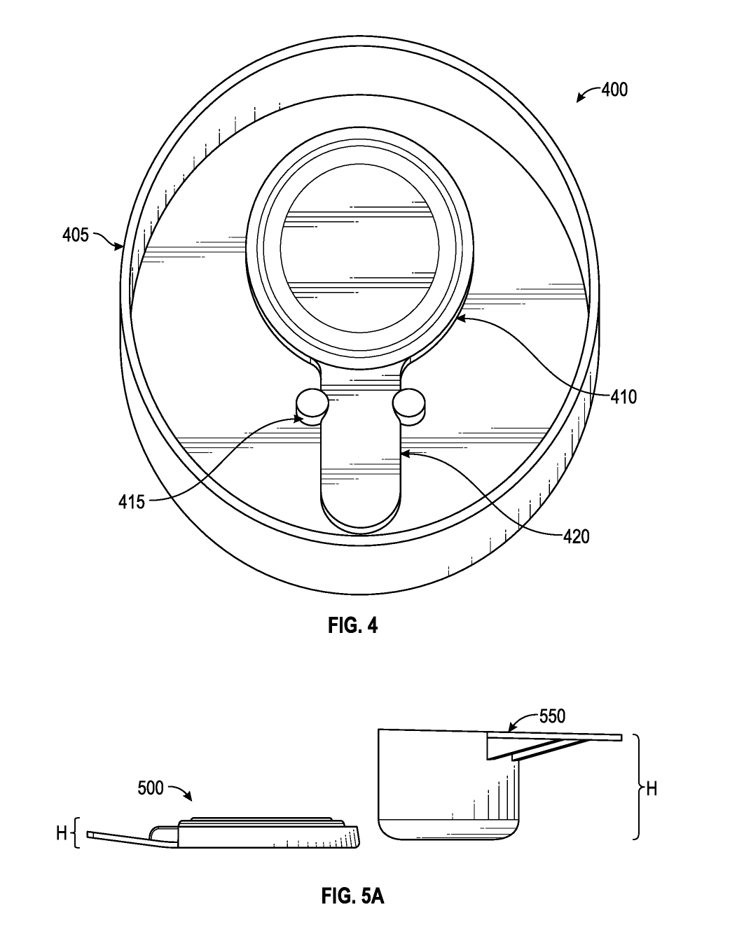

FIG. 4 references an additional way to attach the dispenser utensil 410 to the underside of a closure or package such as lid 405. According to this embodiment, the sides of the handle 420 of the dispending utensil 410 allow for a snap in like fit in connection with two appendages 415. In this embodiment the width of the handle 420 corresponds with a distance between opposing surfaces of the pegs 415 forming means for releasably securing the dispensing utensil 410 to the internal surface of the lid 405 such as a mechanical fit between the appendages 415 and handle 420.

Referring collectively to FIGS. 2, 3, and 4 various mechanical interlocking means are shown for securing a dispensing utensil to the internal surface of a lid. Such, means for repeatedly securing the dispensing utensil to the internal surface of the lid allows for repeated removal of the dispensing utensil from the internal surface of the lid and allows for repeated reattachment of the dispensing utensil to the internal surface. Thus, the removal and replacement of the dispensing utensil to and from the internal surface of the lid may be accomplished multiple times during a series of dispensing actions over the use of the product held therein until the product is depleted. Accordingly, the container may also be refilled with the product. And, the container including the container system for dispensing the product including the dispensing utensil, lid and container may continue to be used until the bulk product is depleted or replaced.

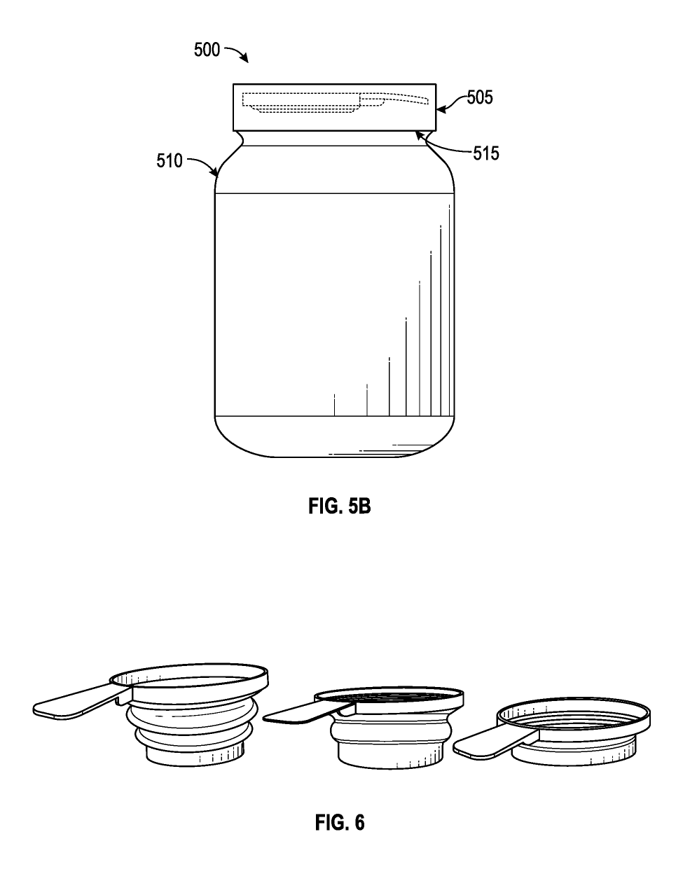

FIG. 5A includes a view of the collapsible dispensing utensil 500 as compared with a convention non-collapsible dispensing scoop 550. As shown, the overall height H of the conventional non-collapsible dispensing scoop 550 is approximately four times the height h of the collapsed dispensing utensil 500 according to the embodiment illustrated in FIG. 5A. As such, the collapsed dispensing utensil 500 is capable of being place within the lid 505 of a container as illustrated in FIG. 5B within which the conventional dispensing utensil 550 is incapable of being placed. As shown in FIG. 5B the size of the lid 505 itself is substantially reduced as compared to a lid 505 capable of enclosing a conventional non-collapsible utensil 550.

The reduction in the size of lid 505 realized by the collapsible and attachable dispensing utensil 500 results in a smaller overall container 510 height. The smaller overall container 510 height results in savings in storage space, transportation space, and display space. In some instances the overall change in container height using the collapsible dispenser utensil may be nominal or less than one centimeter as compared to a conventional container or lid. The lack of increase in height, or nominal increase in height, of the lid 505 as opposed to a conventional dispenser utensil 550 being a magnitude greater thus results in several important advantages over a convention container.

In certain embodiments the collapsible dispensing utensil 500 can have a collapsed thickness that allows for a minimal increase in space between a seal 515 disposed over the bulk product and the inner surface of the lid 505. This reduction in increased lid volume required to contain a conventional dispensing utensil (e.g. a “scoop”) further reduces the overall package size of the manufactured, stored, and sold product as well as the container 510. In some instances, the conventional sealed container may be used with only a small change in height of the lid 505 to accommodate the collapsed dispenser 500

FIG. 6 illustrates various sizes of collapsible dispending utensils where these teachings allow for desired dosage dispenser to be compressed and housed, removed, expanded, replaced and stored in a lid, closure, or packaging. The manufacturing capabilities in making collapsible, expandable, and flexible products using various plastics and combinations of resins with appropriate sizing designs based on the circumference and dimensions allow the collapsible dispensing utensil to be housed and attached inside lids and closures.

The collapsible dispensing utensil is manufactured in various sizes, based on the needs of the product. For example, the cup size in volume of the collapsible dispensing utensils may range from 60 cc, 50 cc and 40 cc or according to the particular embodiment. The collapsible dispensing utensil can expand and/or collapse to differing dosage levels according to the level of expansion in order to offer optional serving sizes. Thus, the collapsible dispensing utensil may have a first, second, and/or third or more expanded/collapsed state corresponding to a particular volume or dosage of product.

The methods of manufacture of the dispensing utensil disclosed herein can include a combination of resins such as silicone so as to allow the dispensing utensil to collapse into a thin space and to be removed and expanded to effectively scoop, dose and pour products. Based on the performance need of the utensil, the collapsible utensil can have a hardened plastic rim and handle or other relatively rigid material. The rim and handle are then adhered/bonded by various manufacturing processes to flexible resins shaped in various forms that can fold in on itself and expand out of itself in an accordion or bellows-like fashion. That is, the sidewalls of the collapsible scoop may fold within or upon one another so as to change the volume of product held therein or so as to place the dispensing utensil in an entirely collapsed storage position. When the flexible bowl of the dispensing utensil is in the collapsed position, it can be equal to the total thickness of the hardened rim and handle allowing storage in limited space sizes.

The dispensing utensil is attached to the inside of the lid using various methods of attachment such as adhesion or other attachment process. The scoop comes attached in the lid in its collapsed form, to minimizing the thickness/height of the closure or lid while still containing needed liner/seal. Various embodiments of the invention allow for closures to contain a properly sized scoop and housing seal to minimize lid height and size.

The collapsed dispensing utensil can be seated between the underside of the lid and above a seal or liner commonly found with bulk material containers. In many instances such seals and liners are required for containment of food products, powders, and tamper evidence. The seal is often placed on the closure at the same time as the scoop to fulfill most automated capping capabilities. The dimensions of the dispensing utensil can be properly sized in circumference, handle length, shape, and dimensions to meet the needs of differing lid sizes and serving sizes. Invention allows for convenient re-attachment of the scoop in its collapsed form. If liner or seal is removed from container, then scoop can be re-attached in collapsed form or expanded form for ease of use, functionality and storage until further use.

The dispensing utensil may come in different cross-sectional form such as oblong, triangular, or other shapes of the rim, bowl, handle, and parts as illustrated in FIG. 7.

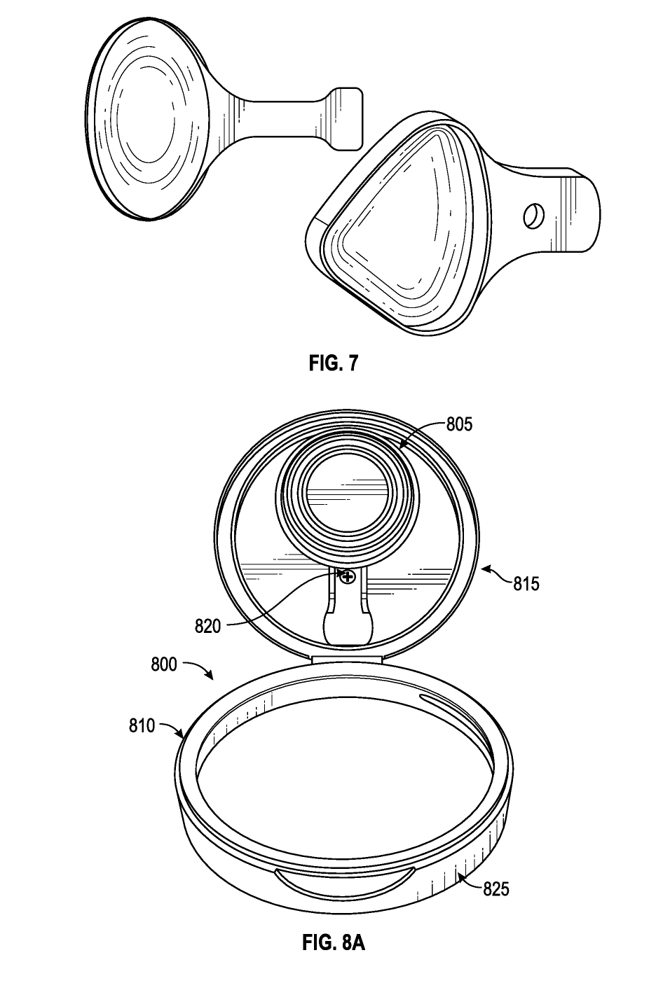

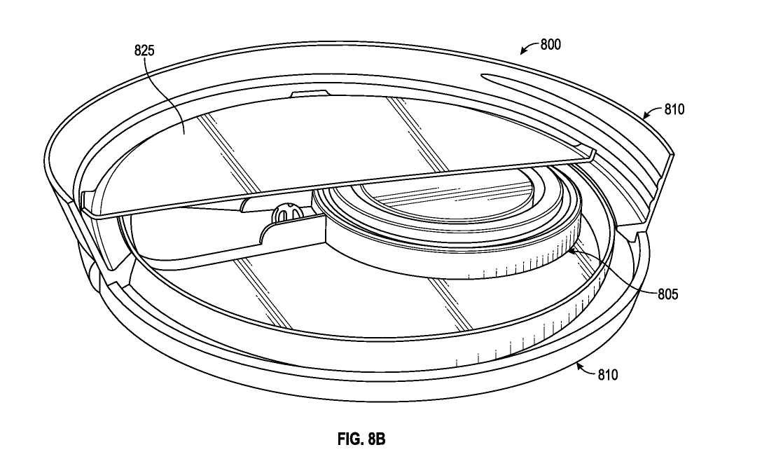

As disclosed and depicted In FIGS. 8A and 8B, a measuring utensil 805 can be collapsible and the collapsed measuring utensil 805 can be held within a top portion including a lid 810 of the overall container system including an attached bulk product reservoir. The dispensing utensil 805 is detachably affixed to an interior surface of the lid 810. And, in several embodiments, the lid 810 can include a pivotable top portion or pivitable door 815 to which the dispending utensil 805 is held via a connection means 820 in this embodiment an peg and hole configuration as previously discussed. Such door 815 of the lid 810 may allow for access to the interior of the container without removing the lid 810 itself. Thus, the lid may have a depression 825, tab, or other access means for opening the door or flap 815 so as to access the dispensing utensil 805 so as to dispense the contents of the attached container.

During use of the “flip-top” pivotal lid 810 illustrated in FIGS. 8A and 8B the lid 810 is screwed on to a container. The expanded dispensing utensil 805 is attached to the underside of the lid 825 in the collapsible form as shown. FIG. 8B shows a cut-out view showing where a liner or seal 825 may be disposed. In this embodiment, the liner 825 is disposed inside of the lid 810 and is inserted and nested next to the attached dispensing utensil 805 on the inside of each lid 810. Liners 825 can often nest behind the threads of a lid/closure 810 or other capping features so that the lid 810 assembles onto the container as desired. This assembly allows the liner 825 to be squeezed between the lid 810 and the container/packaging that the lid 810 is coupled to. Since most lids or other closures 810 come with a liner or seal, the collapsed dispensing utensil 805 is made to fit in this relatively small space and still meet the dosage needs of the product once removed and expanded.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

The present invention may be embodied in other specific forms without departing from its spirit or essential characteristics. The described embodiments are to be considered in all respects only as illustrative and not restrictive. The scope of the invention is, therefore, indicated by the appended claims and the appended figures. All changes which come within the meaning and range of equivalency of the claims are to be embraced within their scope.

What is claimed is:

1. A collapsible dispenser utensil for dispensing a material held within a container comprising:
a collapsible cup portion; and
a handle attached to the collapsible cup portion.

2. An apparatus according to claim 1, wherein the collapsible cup portion is made of a flexible polymer.

3. A collapsible dispenser utensil according to claim 1, further comprising a rigid rim.

4. A collapsible dispenser utensil according to claim 1, the handle including mechanical means for attaching the utensil to an interior surface of a container lid.

5. A collapsible dispenser utensil according to claim 1, the collapsible cup portion having foldable sides.

6. A collapsible dispenser utensil according to claim 5, wherein the foldable sides have a progressively smaller diameter such that successive sides progressively fold within a perimeter of an upper rim when collapsed.

7. A container system comprising:
the collapsible dispenser utensil of claim 1; and
a lid including an interior surface, the interior surface of the lid including mechanical means for releasably attaching to the collapsible utensil.

8. A container system according to claim 7, further comprising:
a container coupled to the lid; and
a seal configured to seal an opening of the container.

9. A container system according to claim 8, wherein the collapsible dispenser utensil is disposed between the seal and the inner surface of the lid.

10. A container system according to claim 7, wherein the attaching means of the lid includes a peg disposed on the lid.

11. A system according to claim 7, the attaching means of the lid includes mechanical locking features.

12. A system according to claim 7, the lid further including a pivotable door forming the internal surface of the lid to which the collapsible utensil is releasably attached.

13. A system according to claim 7, the attaching means of the utensil including a hole corresponding to a peg disposed on the lid.

13. A system according to claim 7, the lid including a hinged internal opening for accessing the contents of the container without removing the lid from the container.

14. A system according to claim 13, further comprising means for attaching the collapsible utensil to an internal surface of the hinged internal opening.

15. A system according to claim 7, further comprising a reservoir affixed to the lid.

16. A system according to claim 17, further comprising a hinged internal opening that allows for internal storage of the collapsible dispensing utensil within the container.

17. A container system, comprising:
a container for holding a liquid or solid product;
a lid affixed to an opening of the container, an internal surface of the lid including a first mechanical interlocking feature;
a collapsible dispensing utensil configured expand to an un-collapsed state so as to hold and dispense a predetermined amount of the product, wherein the collapsible dispensing utensil includes a second interlocking feature,
wherein the first and second interlocking features allow for successive removal and reattachment of the collapsible dispensing utensil to the interior surface of the lid.

18. A container system according to claim 17, the lid including a pivotable door having an internal surface to which the collapsible dispensing utensil is selectively attached.
